(19) United States
(12) Patent Application Publication
(10) Pub. No.: US 2013/0131204 A1
(43) Pub. Date: May 23, 2013

(54) PROCESS FOR PREPARING POLYMER POLYOLS

(71) Applicants: Paulus Jacobus Fennis, HW Amsterdam (NL); Martinus Johannes Maria Lelieveld, HW Amsterdam (NL)

(72) Inventors: Paulus Jacobus Fennis, HW Amsterdam (NL); Martinus Johannes Maria Lelieveld, HW Amsterdam (NL)

(21) Appl. No.: 13/813,460

(22) PCT Filed: Aug. 3, 2011
(86) PCT No.: PCT/EP11/63388

§ 371 Date: Jan. 31, 2013

(30) Foreign Application Priority Data
Aug. 3, 2010 (EP) 10171770.0

(51) Int. Cl. C08G 65/34

(52) U.S. Cl. CPC C08G 65/34
USPC 521/163; 528/392

(57) ABSTRACT

The invention relates to a process for the preparation of a polymer polyol, which process comprises mixing in a reactor vessel a base polyol, one or more ethylenically unsaturated monomers, a polymerization initiator, optionally a macromer, and optionally a chain transfer agent, and polymerizing the mixture thus obtained at a temperature of 50 to 200 ° C., wherein the monomer(s) and initiator are dosed simultaneously to the reactor vessel and wherein during the time period of simultaneously dosing the monomer(s) and initiator the dosing weight ratio of initiator to monomer(s) is increased.

The present invention relates to a process for preparing polymer polyols.

Polymer polyols are commonly used for the manufacture of flexible polyurethane foams. Flexible polyurethane foams are widely used in numerous applications. Main sectors of application are automotive and aircraft industry, upholstered furniture and technical articles. For instance, full foam seats, top pads for the seats and restraints for back and head, all made from flexible polyurethane foam, are widely used in cars and aeroplanes. Other applications include the use of flexible polyurethane foam as carpet backings, bedding and mattresses, foamed seat saddles for motorbikes, gaskets between a car body and its lights, lip seals of air filters for engines and insulating layers on car parts and engine parts to reduce sound and vibration.

A typical process for preparing a polymer polyol, that is to say a system wherein a polymer is dispersed in a base polyol, comprises mixing in a reactor vessel, a base polyol, one or more ethylenically unsaturated monomers, a polymerization initiator, optionally a macromer, and optionally a chain transfer agent, and polymerizing the mixture thus obtained at a temperature of 50 to 200° C. Azobis(2-methylbutyronitrile), that is to say AMBN, is an initiator that is commonly used in the production of polymer polyols from ethylenically unsaturated monomer and base polyol. For example, WO199940144 discloses that suitable polymerization initiators in polymer polyol production include peroxide compounds and azo compounds.

A general desire in the manufacture of polymer polyols is the optimisation of the conversion of the ethylenically unsaturated monomer(s), in the presence of base polyol, into the desired polymer. It is an object of the present invention to provide a polymer preparation process wherein such conversion is improved.

Surprisingly, it was found that this object can be achieved by increasing the dosing weight ratio of initiator to monomer(s) during the time period of simultaneously dosing the monomer(s) and initiator.

Accordingly, the present invention relates to a process for the preparation of a polymer polyol, which process comprises mixing in a reactor vessel a base polyol, one or more ethylenically unsaturated monomers, a polymerization initiator, optionally a macromer, and optionally a chain transfer agent, and polymerizing the mixture thus obtained at a temperature of 50 to 200° C., wherein the monomer(s) and initiator are dosed simultaneously to the reactor vessel and wherein during the time period of simultaneously dosing the monomer(s) and initiator the dosing weight ratio of initiator to monomer(s) is increased.

In the present invention, simultaneously dosing of monomer(s) and initiator to the reactor vessel does not imply that said monomer(s) and initiator should be dosed in admixture to the reactor vessel. Said monomer(s) and initiator may be dosed separately (at the same time or consecutively), intermittently, or in admixture.

In the present invention, monomer(s) and initiator are dosed simultaneously to the reactor vessel, or at least substantially simultaneously. Hence, this does not imply that during the entire polymer polyol preparation process monomer(s) and initiator should be always be dosed precisely simultaneously. For example, a portion of the monomer(s) may be dosed in a first stage of the entire process without dosing of initiator in that first stage. Then, in a second stage of that process monomer(s) and initiator may be dosed simultaneously to the reactor vessel. By use of the term “substantially simultaneously” it is meant that the process monomers and the initiator are dosed in a manner that allows them to react at around the same time. It will be understood by the skilled person that actual dosing of the individual components can be alternating, concurrent or immediately consecutive in order to achieve a similar result.

Further, in the present invention, monomer(s) and initiator are dosed simultaneously during a certain time period. This means that said monomer(s) and initiator are not dosed all-at-once at a certain point in time, but during a time period which may be of from 15 minutes to 10 hours, suitably of from 1 to 5 hours.

Still further, in the present invention, during the time period of simultaneously (or substantially simultaneously) dosing the monomer(s) and initiator the dosing weight ratio of initiator to monomer(s) is increased. Within the present specification, the dosing weight ratio of initiator to monomer(s) is defined as the ratio of the weight of dosed initiator to the total weight of dosed initiator and monomer(s).

In the present invention, during the time period of simultaneously dosing the monomer(s) and initiator the dosing weight ratio of initiator to monomer(s) may be increased either continuously or stepwise. That is to say, the increase may be by relatively small or large increments.

Further, the maximum of said dosing weight ratio does not have to be within the final part of the time period of simultaneously dosing the monomer(s) and initiator. For example, the maximum may be in the middle of said time period. However, it is preferred that the maximum is in the fourth quarter of said time period. Further, it is preferred that during the third quarter of the time period of simultaneously dosing the monomer(s) and initiator the dosing weight ratio of initiator to monomer(s) is lower than the dosing weight ratio of initiator to monomer(s) in the fourth quarter of said time period.

The increase in the dosing weight ratio of initiator to monomer(s) during the time period of simultaneously dosing the monomer(s) and initiator, may be accomplished by increasing the weight of initiator as dosed per time unit or by decreasing the weight of monomer(s) as dosed per time unit or by a combination of both. Normally, the initiator is dosed as a solution in base polyol. In the latter case, the weight of initiator as dosed per time unit can be increased by increasing the concentration of such solution. In a case where it is desired to keep the concentration of such solution constant, the dosing weight ratio of initiator to monomer(s) may be increased either by decreasing the weight of monomer(s) as dosed per time unit or by increasing the weight of the initiator solution as dosed per time unit.

The polymerization initiator is usually applied in an amount of from 0.01 to 5% by weight based on total weight of monomers. Said amount refers to the total weight of all dosed initiator based on the total weight of all dosed monomer. Suitable polymerization initiators include both peroxide compounds and azo compounds. A mixture of initiators may also be used. Examples of suitable azo compounds are azobis(isobutyronitrile) (AIBN) and azobis(2-methylbutanenitrile) (AMBN).

In the present process, the polymerization initiator is optionally a peroxide compound. Suitably, the initiator(s) is (are) only a peroxide compound, that is to say no initiator other than a peroxide compound is used. Examples of suitable peroxides are dibenzoyl peroxide, lauroyl peroxide, t-butyl hydroperoxide, benzoyl peroxide and di-t-butyl peroxide.

In a specific embodiment of the present invention the peroxide compound used as the polymerization initiator in the present process, is a compound of formula

R₁—C(═O)—O—O—R₂ (I)

wherein R₁ is an alkyl group and R₂ is an alkyl group of formula

—C(R₃)(R₄)—C(R₅)(R₆)(R₇) (II)

wherein R₃ and R₄ are the same or different and are an alkyl group, R₅, R₆ and R₇ are the same or different and are a hydrogen atom or an alkyl group; or

where the polymerization initiator of formula (I) comprises an R₂ alkyl group of formula

—C(R₃)(R₄)—C(R_{5′})(R_{6′})—C(R_{7′})(R_{8′})(R_{9′}) (III)

wherein R₃ and R₄ are the same or different and are an alkyl group, R_{5′} and R_{6′} are the same or different and are a hydrogen atom or an alkyl group, R_{7′}, R_{8′} and R_{9′} are the same or different and are a hydrogen atom or an alkyl group, with the proviso that R_{7′}, R_{8′} and R_{9′} are not all hydrogen atoms in a case where both R_{5′} and R_{6′} are hydrogen atoms.

Typically, R₁ is an alkyl group having up to 10 carbon atoms, more suitably of from 4 up to 10 carbon atoms. Examples of suitable alkyl groups for R₁ are tert-butyl, 1-ethylpropyl, 1-ethylpentyl and 2,4,4-trimethylpentyl. In a specific embodiment of the invention, R₁ is 1-ethylpentyl.

In relation to Formula (II), typically, R₃ and R₄ are an alkyl group having up to 10 carbon atoms, more suitably of from 1 up to 4 carbon atoms. R₃ and R₄ may be selected from methyl or ethyl. In one embodiment of the invention, R₃ and R₄ are the same and are both methyl.

R₅, R₆ and R₇ may all be a hydrogen atom in which case —C(R₅)(R₆)(R₇) is a methyl group. Alternatively, at least one of R₅, R₆ and R₇ is an alkyl group and may be selected from a methyl group, an ethyl group or a tertiary butyl group. In a specific embodiment of the invention both R₅ and R₆ are hydrogen atoms and R₇ is an alkyl group that has up to 10 carbon atoms, such as including a methyl, ethyl or tertiary butyl (tert-butyl)group.

In relation to Formula (III), typically, R₃ and R₄ are an alkyl group having up to 10 carbon atoms, more suitably of from 1 up to 4 carbon atoms. R₃ and R₄ may be selected from methyl or ethyl. In one embodiment of the invention, R₃ and R₄ are the same and are both methyl.

In a case where R_{5′} and R_{6′} are an alkyl group, the alkyl group suitably has up to 10 carbon atoms, optionally of from 1 up to 4 carbon atoms. R_{5′} and R_{6′} may be methyl or ethyl.

In a case where one or more of R_{7′}, R_{8′} and R_{9′} are an alkyl group, the alkyl group has up to 10 carbon atoms, optionally at least 1 and up to 4 carbon atoms. R_{7′}, R_{8′} and R_{9′} may be methyl or ethyl. In a specific embodiment of the invention, R_{7′}, R_{8′} and R_{9′} are all the same and are methyl.

Examples of the R₂ alkyl groups of formula (II) are tertiary-butyl, 1,1-dimethylpropyl, 1,1-dimethylbutyl, 1,1,3-trimethylbutyl, 1,1,3,3-tetramethylbutyl, 1,1,2-trimethylpropyl, 1,1,2,2-tetramethylpropyl and 1,1,2,2-tetramethylbutyl. In an embodiment of the invention the R₂ alkyl group is 1,1,3,3-tetramethylbutyl.

In specific embodiments of the invention, R₁ and R₂ are alkyl groups containing no heteroatoms, such as oxygen, nitrogen and/or sulfur.

Examples of the R₂ alkyl groups of formula (III) include 1,1-dimethylbutyl, 1,1,3-trimethylbutyl, 1,1,3,3-tetramethylbutyl, 1,1,2-trimethylpropyl, 1,1,2,2-tetramethylpropyl and 1,1,2,2-tetramethylbutyl.

In a specific embodiment of the invention, the initiator is 1,1,3,3-tetramethylbutyl peroxy-2-ethylhexanoate, that is to say a compound of formula (I) wherein R₁ is 1-ethylpentyl and R₂ is 1,1,3,3-tetramethylbutyl.

Using said 1,1,3,3-tetramethylbutyl peroxy-2-ethylhexanoate in the production of polymer polyols is suggested in EP1624005. Said EP1624005 discloses a process for making a polymer polyol, comprising free-radical polymerizing a base polyol, a high potency preformed stabilizer, at least 1 ethylenically unsaturated monomer, at least 1 free-radical polymerization initiator, and a chain transfer agent. Said 1,1,3,3-tetramethylbutyl peroxy-2-ethylhexanoate is suggested as only 1 of many initiators that could be used in such process. Besides, EP1624005 additionally requires the presence of a preformed stabilizer and also that the polymer polyol to be an “ultra-high solids” polymer polyol. As defined in EP1624005, this means that the content of solid polymer in the polymer polyol is greater than 60 wt. %. In addition, the reaction temperatures disclosed in said EP1624005 are broadly in excess of 120° C. for initiators of the type used in the present invention.

Preferably, in the present invention, the solid polymer content of the polymer polyol, which is the amount of solid polymer based on the total amount of polymer and polyol, is at most 60 wt. %. Suitably, the solid polymer content is of from 25 to 55 wt. %. Preferably, the solid polymer content is of from 30 to 55 wt. %, more preferably of from 35 to 55 wt. %.

In a specific embodiment of the invention the polymerization temperature is less than about 120° C., suitably less than 115° C., more suitably about 115° C. or less.

The present process may be a continuous, batch or semi-batch process. However, the present process works well as a batch or semi-batch process. In the latter case one or more compounds are added to the reactor continuously for a limited amount of time. Such continuous addition may take place when adding the compounds to be mixed in an initial phase and/or when adding the compounds after such initial phase. Batch operation and semi-batch operation differ from continuous operation in that in batch and semi-batch operation the product is removed from the reactor discontinuously.

In the present process, a polymer polyol is prepared by mixing a base polyol, one or more ethylenically unsaturated monomers, a polymerization initiator, optionally a macromer, and optionally a chain transfer agent, and polymerizing the mixture thus obtained at a temperature of 50 to 200° C. Processes for preparing polymer polyols are for example disclosed in WO1999040144, WO2003097712 and WO2008122581.

Such polymer polyol preparation is preferably carried out in a stainless steel reactor vessel. Further, preferably, the reactor vessel is a continuously stirred tank reactor, more preferably a stainless steel, continuously stirred tank reactor.

The temperature at which polymerization is carried out, is comprised in the range of from 50 to 200° C., suitably 70 to 150° C., more preferably 80 to 130° C. In a specific embodiment of the invention the polymerization temperature is less than about 120° C., suitably less than 115° C., more suitably about 115° C. or less. Further, it is preferred that during the entire polymerization process, the temperature is maintained constant at a certain value, with the proviso that a deviation of plus or minus 10° C. from said value is still allowable. Within said preferred embodiment, it is preferred that during the entire polymerization process, the temperature is maintained at a value comprised in the range of from 70 to 120° C., preferably 80 to 115° C.

The pressure at which polymerization may be carried out, is suitably comprised in the range of from 0.01 to 5 bar absolute, more suitably 0.05 to 4 bar absolute.

The base polyol used preferably is a polyether polyol, also frequently referred to as polyoxyalkylene polyols. Such polyether polyols are typically obtained by reacting a starting compound having a plurality of active hydrogen atoms with one or more alkylene oxides, such as ethylene oxide, propylene oxide, butylene oxide or mixtures of two or more of these. Suitable polyether polyols are those having a nominal molecular weight in the range of from 350 to 15,000 In addition, the polyether polyols suitably have an average nominal functionality (Fn) of at least 2.0, typically greater than 2.0 and in one embodiment of the invention an average Fn of at least 3.0. In a further embodiment of the invention it has been found particularly advantageous to use polyols having a molecular weight in the range of from 2000 to 14,000. Such polyols preferably further have a Fn greater than 2.5, and suitably in the range of from around 2.5 to around 6.0. The hydroxyl value of the polyol suitably has a value of from 10 to 150 mg KOH/g, more suitably of from 20 to 75 mg KOH/g. Examples of suitable polyols include CARADOL SC46-02, CARADOL SC36-13, CARADOL MC36-03, CARADOL SC56-02, CARADOL SC36-11, CARADOL SC48-03 and CARADOL MH56-03 (CARADOL is a trademark). Most preferably, CARADOL SC56-02 polyol and CARADOL SC48-03 polyol are used.

Suitable ethylenically unsaturated monomers for preparing the dispersed polymer include vinyl aromatic hydrocarbons, like styrene, alpha-methyl styrene, beta-methyl styrene and various other alkyl-substituted styrenes. Of these, the use of styrene is preferred. The vinyl aromatic monomer may be used alone or in combination with other ethylenically unsaturated monomers, such as acrylonitrile, methacrylonitrile, vinylidene chloride, various acrylates and conjugated dienes like 1,3-butadiene and isoprene. Preferred ethylenically unsaturated monomers to be used for the purpose of the present invention are styrene and acrylonitrile in a weight ratio of from 30:70 to 100:0. It is, however, particularly preferred to use styrene alone or a combination of styrene and acrylonitrile in a weight ratio styrene:acrylonitrile of from 50:50 to 75:25, resulting in dispersed polystyrene and styrene-acrylonitrile (SAN) copolymer, respectively.

Preferably, a macromer is fed when preparing the polymer polyol. Within the present specification, a macromer is considered to be a polyol which may contain one or more unsaturations and which purpose is to effect a stable dispersion of the polymer particles in the base polyol, said polymer particles obtained from polymerizing one or more ethylenically unsaturated monomers. Macromers which can be used include, but are not limited to the reaction product of a polyol with a reactive unsaturated compound such as maleic anhydride, phthalic anhydride, fumaric acid, 1,1-dimethyl-m-isopropenyl-benzyl-isocyanate, isocyanatoethylmethacrylate, hydroxyethylmethacrylate, hydroxypropyl acrylate, methyl methacrylate, acrylic and methacrylic acid, methacroyl chloride, glycidyl methacrylate and allyl glycidyl ether. If a polycarboxylic acid or anhydride is employed, it is preferred to react the unsaturated polyol with an alkylene oxide. The polyol for preparing the macromer preferably has a hydroxyl functionality of at least 2.

A suitable macromer has been described in WO199940144. Such macromer is suitable as a stabiliser precursor in a polymer polyol, and has been prepared by a process which comprises reacting a polyol with a cyclic dicarboxylic acid anhydride not containing any polymerizable double bond, and subsequently reacting the adduct thus obtained with an epoxide compound containing a polymerizable double bond. The polyol preferably is sorbitol or a mixture of sorbitol with one or more diols (including water), said sorbitol or said mixture having reacted with a mixture of propylene oxide and ethylene oxide. The cyclic dicarboxylic acid anhydride preferably is phthalic anhydride. The epoxide compound preferably is glycidyl methacrylate or glycidyl acrylate. The adduct can first partly be reacted with a di- or higher functional epoxide compound before being reacted with the epoxide compound containing a polymerizable double bond. Further, the polyol can be reacted with a di-or higher functional isocyanate compound preceding the reaction between the polyol and the cyclic dicarboxylic acid anhydride. A method for preparing the macromer comprises reacting the adduct first partly with the epoxide compound containing a polymerizable double bond and subsequently reacting the reaction product thus obtained with a di- or higher functional epoxide compound or a di-or higher functional isocyanate compound.

The macromer suitably has a nominal molecular weight of at least 4000, typically in the range of from 5000 to 50,000.

The amount of ethylenically unsaturated monomers present during the process of the present invention can vary widely. At any time during the process according to the present invention, the amount of ethylenically unsaturated monomer will generally differ between of from 0 to 60% by weight based on total weight of base polyol, polymer, monomer(s) and optionally macromer. It is possible to have all base polyol fed initially, while it is also possible to add the majority of the base polyol after initiation of polymerization.

The additional base polyol optionally added after initiation of polymerization can be the same or can be different from the base polyol as initially fed. Preferably, the base polyol remains the same.

Chain transfer agents may also be added to or be present in the polymerization reaction medium. Preferably, they are fed to the reactor in the initial phase of the present process. The use of chain transfer agents and their nature is known in the art. Chain transfer agents enable a control of the molecular weight and/or the cross-linking occurring between the various polymer molecules and hence may affect stability of the polymer polyol. If used at all, a chain transfer agent is suitably used in an amount of from 0.1 to 20% by weight, more suitably 0.2 to 10% by weight, and most suitably 0.3 to 7% by weight, based on total weight of end product. Examples of suitable chain transfer agents are 1-butanol, 2-butanol, isopropanol, ethanol, methanol, cyclohexane and mercaptans, such as dodecanethiol, ethanethiol, 1-heptanethiol, 2-octanethiol and toluenethiol. Preferably, isopropanol is used as a chain transfer agent.

Other compounds, such as compounds facilitating mixing of the various components, compounds which have a viscosity-lowering effect and/or compounds which enable one or more of the components used to better dissolve in the reaction medium may also be applied. An example of a compound having a viscosity-lowering effect, thus enabling a better mixing of the components, is toluene. Auxiliaries like toluene can be present in the feed and/or in the reactor.

A specific embodiment of the invention permits for the polymerization reaction to occur substantially in the absence of a preformed stabilizer. Preformed stabilizer is typically a small amount of a preformed copolymer of styrene, acrylonitrile and a macromer in the polymerization mixture that is formed separately and dosed into the reaction in order to stabilize the mixture. In this way the preformed stabilizer is a component that is added to the process as a separate ingredient. It is usually the reaction product of a macromer, in presence of styrene, acrylonitrile, and solvents/chain transfer agents like e.g. IPA, toluene and/or a polyol, and also a radical initiator. The preformed stabilizer is typically stored in a buffer tank/vessel from which it is dosed to the polymer polyol process. In the present invention it is not necessary to introduce one or more preformed stabilizer components to the reaction mixture prior to the polymerization step which represents a considerable advantage over previously known methods.

The present invention also relates to a polymer polyol, preferably a by-product free polymer polyol, obtainable by the process of the present invention.

The polymer polyol obtainable by the process of the present invention is very suitable for the preparation of polyurethane foams, especially flexible polyurethane foams, by reacting it with a suitable polyisocyanate in the presence of one or more suitable polyurethane catalysts, a suitable blowing agent, one or more surfactants, and optionally a cross-linking agent. This reaction is also commonly denoted as foaming. Therefore, the present invention also relates to a process for preparing a polyurethane foam by foaming a composition comprising a polymer polyol obtainable by the process of the present invention and a polyisocyanate component.

Further, the present invention relates to a polyurethane foam obtainable by said foaming process. Still further, the present invention relates to a shaped article comprising said polyurethane foam.

The invention is further illustrated in the following non-limiting Examples.

### Reference Example 1

A polymer polyol was prepared by applying the following batch procedure, wherein the following compounds were used:

Base polyol=a polyether polyol containing randomly distributed ethyleneoxy and propyleneoxy monomers in the weight ratio of about 11/89. It was produced by using glycerol as the initiator and potassium hydroxide (KOH) as the catalyst. The base polyol had a weight average molecular weight of about 3,000 and had a OH value of about 54 mg KOH/g.

Styrene and acrylonitrile=ethylenically unsaturated monomers. 1,1,3,3-Tetramethylbutyl peroxy-2-ethylhexanoate=polymerization initiator.

Macromer=a polyol (in accordance with

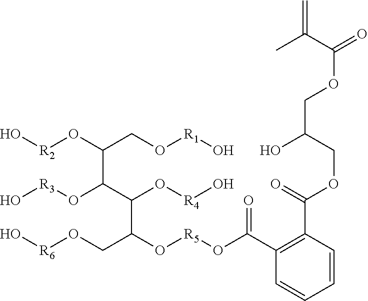

WO1999040144) having the following structure:

wherein R1 to R6 represent chains comprising randomly distributed propylene oxide (PO) and ethylene oxide (EO) monomers. The weight ratio of PO to EO in these chains was about 82/18. The weight average molecular weight per chain, averaged over all six chains, amounted to about 2,000.

IPA=isopropanol (chain transfer agent).

In a first stage of the batch, 182.5 g base polyol, 40.4 g macromer and 45.5 g IPA were fed to a reactor. The reactor was a stainless steel, continuously stirred tank reactor. Further, heating of the contents of the reactor to 100° C. was performed. This heating was attained by external heating of the reactor wall.

In a second stage of the batch, 52.3 g of a 5.0 wt. % solution of the initiator in the base polyol, 296.3 g base polyol, 295.7 g styrene and 140.1 g acrylonitrile were dosed simultaneously to the reactor. Further, during the time period of simultaneously dosing the monomers and initiator the dosing weight ratio of initiator to monomers was kept constant. Said dosing weight ratio concerns the ratio of the weight of dosed initiator to the total weight of dosed initiator and monomers. The value for said constant dosing weight ratio was 6 g/kg. The polymerization temperature within the reactor was maintained at 100° C. The total dosing time for dosing the initiator and monomers was 100 minutes. The solid polymer content of the final polymer polyol product was about 43 wt. %.

### Example 1

A polymer polyol was prepared by applying the batch procedure of Reference Example 1, with the exception that in the second stage of the batch the initiator was dosed as a 4.3 wt. % solution of initiator in base polyol during the first 88% of the total dosing time, and as a 10.6 wt. % solution of initiator in base polyol during the remaining 12% of the total dosing time. That is to say, the total dosing time as well as the total dosing amount of initiator remained the same.

The dosing weight ratio of initiator to monomers during each of said 2 time periods within said second stage of the batch were kept constant, at values of 5.13 g/kg during the first 88% of the total dosing time and 12.56 g/kg during the remaining 12% of the total dosing time.

### Example 2

A polymer polyol was prepared by applying the batch procedure of Reference Example 1, with the exception that in the second stage of the batch the initiator was dosed as a 3.8 wt. % solution of initiator in base polyol during the first 88% of the total dosing time, and as a 14.5 wt. % solution of initiator in base polyol during the remaining 12% of the total dosing time. That is to say, the total dosing time as well as the total dosing amount of initiator remained the same.

The dosing weight ratio of initiator to monomers during each of said 2 time periods within said second stage of the batch were kept constant, at values of 4.54 g/kg during the first 88% of the total dosing time and 17.1 g/kg during the remaining 12% of the total dosing time.

In the following table, the overall conversions of the monomers are mentioned.

| | Overall styrene | Overall acrylonitrile |
|---|---|---|
| | conversion (wt. %) | conversion (wt. %) |
| Reference | 98.2 | 97.5 |
| Example 1 | | |
| Example 1 | 98.5 | 97.8 |
| Example 2 | 98.8 | 98.0 |

From the above table, it appears that by increasing the dosing weight ratio of initiator to monomers during the time period of simultaneously dosing the initiator and monomers, the conversion of both styrene and acrylonitrile is likewise surprisingly increased.

Although particular embodiments of the invention have been disclosed herein in detail, this has been done by way of example and for the purposes of illustration only. The aforementioned embodiments are not intended to be limiting with respect to the scope of the appended claims, which follow. It is contemplated by the inventors that various substitutions, alterations, and modifications may be made to the invention without departing from the spirit and scope of the invention as defined by the claims.

1. A process for the preparation of a polymer polyol, which process comprises mixing in a reactor vessel a base polyol, one or more ethylenically unsaturated monomers, a polymerization initiator, optionally a macromer, and optionally a chain transfer agent, and polymerizing the mixture thus obtained at a temperature of 50 to 200° C., wherein the monomer(s) and initiator are dosed substantially simultaneously to the reactor vessel and wherein during the time period of substantially simultaneously dosing the monomer(s) and initiator the dosing weight ratio of initiator to monomer(s) is increased.

2. The process of claim 1, wherein the initiator comprises a peroxide compound.

3. The process of claim 2, wherein the initiator is of formula
R1—C(═O)—O—O—R2 (I)
wherein R1 is an alkyl group and R2 is an alkyl group of formula
—C(R3)(R4)—C(R5)(R6)(R7) (II)
wherein R3 and R4 are the same or different and are an alkyl group, R5, R6 and R7 are the same or different and are a hydrogen atom or an alkyl group.

4. The process of claim 3, wherein at least one of R5, R6 and R7 is an alkyl group and is selected from a methyl group, an ethyl group or a tertiary butyl group

5. The process of claim 3, wherein R2 is selected from: tertiary-butyl, 1,1-dimethylpropyl, 1,1-dimethylbutyl, 1,1,3-trimethylbutyl, 1,1,3,3-tetramethylbutyl, 1,1,2-trimethylpropyl, 1,1,2,2-tetramethylpropyl or 1,1,2,2-tetramethylbutyl.

6. The process of claim 2, wherein the initiator is of formula
R1—C(═O)—O—O—R2 (I)
wherein R1 is an alkyl group and R2 is an alkyl group of formula
—C(R3)(R4)—C(R5′)(R6′)—C(R7′)(R8′)(R9′) (III)
wherein R3 and R4 are the same or different and are an alkyl group, R5′ and R6′ are the same or different and are a hydrogen atom or an alkyl group, R7′, R8′ and R9′ are the same or different and are a hydrogen atom or an alkyl group, with the proviso that R7, R8 and R9 are not all hydrogen atoms in a case where both R5 and R6 are hydrogen atoms.

7. The process of claim 6, wherein R2 is 1,1-dimethylbutyl, 1,1,3-trimethylbutyl, 1,1,3,3-tetramethylbutyl, 1,1,2-trimethylpropyl, 1,1,2,2-tetramethylpropyl or 1,1,2,2-tetramethylbutyl.

8. The process according of claim 7, wherein R2 is 1,1,3,3-tetramethylbutyl.

9. The process of claim 3, wherein R1 is an alkyl group having up to 10 carbon atoms.

10. The process of claim 9, wherein R1 is 1-ethylpentyl.

11. The process of claim 1, wherein the base polyol has a nominal molecular weight in the range of from 350 to 15,000 and an average nominal functionality (Fn) of at least 2.0.

12. The process of claim 1, wherein the ethylenically unsaturated monomers are styrene and acrylonitrile in a weight ratio of from 30:70 to 100:0.

13. The process of claim 1, wherein a macromer is used and the macromer is obtained by reacting a polyol with a cyclic dicarboxylic acid anhydride not containing any polymerizable double bond, and subsequently reacting the adduct thus obtained with an epoxide compound containing a polymerizable double bond.

14. The process of claim 13, wherein the cyclic dicarboxylic acid anhydride is phthalic anhydride.

15. A process for preparing a polyurethane foam by foaming a composition comprising a polymer polyol obtainable by the process according to claim 1 and a polyisocyanate component.
